(19) United States
(12) Patent Application Publication
(10) Pub. No.: US 2014/0167963 A1
(43) Pub. Date: Jun. 19, 2014

(54) SYSTEM AND METHOD FOR MONITORING AN AREA USING NFC TAGS

(71) Applicant: Simon Ferragne, Boisbriand (CA)

(72) Inventor: Simon Ferragne, Boisbriand (CA)

(21) Appl. No.: 13/716,563

(22) Filed: Dec. 17, 2012

(51) Int. Cl. G08B 13/24

(52) U.S. Cl. CPC G08B 13/2462
USPC 340/572.1

(57) ABSTRACT

A system and method for monitoring an area using NFC tags. The NFC tags may be provided at predefined locations within the area, and may have different functions. A sensing device scans the NFC tags and sends sensing data to a remote server over a telecommunication network in real time. The sensing data may include one or more of: the ID of the tag being sensed, the timestamp and/or position of the sensing device at the time of sensing, the ID of the employee performing the sensing, etc. The server detects the ID of the NFC tag from the sensing data received from the sensing device, and performs the function(s) associated with the sensed tag.

### BACKGROUND

(a) Field

The subject matter disclosed generally relates to security systems.

(b) Related Prior Art

In addition to traditional threats to security such as burglary, vandalism and arson, today's complex national and international political conflicts are putting increased pressure on facilities and organizations of all kinds to provide effective security systems for the safety and protection of personnel, property and surroundings.

In general, the structure and function of most security systems involves electronic surveillance equipment monitored at a centralized location. Current development of security systems attempts to do away with human-oriented services and replace the human security guard with high technology solutions to security problems.

Only a limited number of currently developed security systems utilize a combination of guards in close conjunction with the electronic equipment. Most of the time, these systems involve one guard who monitors a video feed or alarm panel for intrusion or other related alerts. However, these methods are prone to hacking. For example, one of the hacking methods includes methods for freezing the picture displayed on the camera. Other methods include disabling the camera and providing a feed of prerecorded video of the area being monitored.

Furthermore, conventional technologies which require the employees to perform some sort of data recording or scanning using a portable device require a data transfer at the end of the shift, whereby the employee plugs the sensing device to a station to transfer the data to a local database. These systems do not allow for a real time monitoring of the security proceedings, nor do they allow for an efficient intervention when the intervention is needed. Another problem associated with these systems is that the data is stored locally which makes it impossible neither to track the employees nor to have access to the data from a remote location.

Therefore, there is a need for a new management system which allows for monitoring the progress of the security personnel and tracking their location in real time.

### SUMMARY

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and “include” variations of these words mean “including but not limited to,” and are not intended to exclude, for example, other additives, components, integers or steps. “Exemplary” means “an example of and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

In an aspect, there is provided, a method for monitoring an area including a plurality of NFC tags provided in predetermined locations within the area, the method comprising dividing the NFC tags into groups, each group including one or more NFC tags; associating a different function to each different group of NFC tags, wherein one or more NFC tags represent checkpoints in the area; receiving real-time or near-time sensing data from a sensing device adapted to sense NFC tags over a telecommunication network, the sensing data including an ID of the NFC tag being sensed and a timestamp representing a time of sensing; and performing the function associated with a given NFC tag, upon receiving sensing data including the ID of the given NFC tag.

In an embodiment, the sensing device may include a positioning system, the method further comprising: receiving a position of the sensing device at the time of sensing; comparing the position of the sensing device with a predetermined location of the NFC tag; and triggering a first alarm when a mismatch is identified.

In another embodiment, the sensing device includes a positioning system, the method further comprising: receiving a position of the sensing device; and triggering a second alarm when the sensing device remains in a certain location for a given period.

In a further embodiment, the sensing device includes a positioning system, the method further comprising receiving a position of the sensing device; and triggering a third alarm when the sensing device leaves the area.

In an embodiment, the method further comprises providing the sensing device with computer readable instructions which when executed cause the sensing device to sense the NFC tags when brought in proximity of the NFC tags, and send the sensing data to a remote host over the telecommunication network in real time or as soon as a connection is available.

In a further embodiment, a panic-alarm function is associated with a first group of NFC tags, the computer readable instructions causing the sensing device to activate an audio/video recorder associated with the sensing device, when sensing one or more NFC tags from the first group of NFC tags; and send a recorded audio/video file to the remote host.

In an embodiment a panic-alarm function is associated with a second group of NFC tags, the method further comprising, upon receiving sensing data including the ID of one or more NFC tags from the second group, sending instructions to the sensing device to activate an audio/video recorder associated with the sensing device; and receiving an audio/video file from the sensing device.

In another embodiment, the sensing device is configured to perform an employee authentication before sensing NFC tags, the computer readable instructions causing the sensing device to include employee authentication information with the sensing data.

In another embodiment, the sensing device authenticates employees using biometric verification, the method further comprising triggering a fourth alarm when a biometric data received/detected at the sensing device does not match any employee.

In a further embodiment, the computer readable instructions cause the sensing device to generate an alarm when a scanning time for a certain checkpoint is past due.

In yet another embodiment, the method further comprises illustrating a status of one or more checkpoints in a user interface.

In an embodiment, the method further comprises color coding illustrated checkpoints using the sensing data and a set of rules specific to each checkpoint.

In a further embodiment, the method further comprises illustrating the area, the checkpoints, and the color associated with each checkpoint on a map provided by a third party.

In a further embodiment, the set of rules comprises a time rule that defines scanning times for each checkpoint.

In a further embodiment, the method further comprises refreshing the user interface every time a new sensing data is received for one of the checkpoints.

In another embodiment, the method further comprises generating a late log for a given checkpoint when a time rule is broken.

In a further embodiment, the method further comprises changing the color of the given checkpoint in accordance with the late log.

In an embodiment, the method further comprises storing the sensing data in a predefined format in a database; and generating one or more reports based on the sensing data stored in the database.

In another aspect, there is provided a method for monitoring an area including a plurality of NFC tags provided in predetermined locations within the area, a portion of the NFC tag representing checkpoints in the area, the method comprising: associating a function to each tag; receiving real-time or near-time sensing data from a NFC sensing device over a telecommunication network, the sensing data including an ID of the tag being sensed and a timestamp representing a time of sensing; and performing the function associated with a given NFC tag, upon receiving sensing data including the ID of the given NFC tag.

In yet another aspect, there is provided a computing device for monitoring an area including a plurality of NFC tags provided in predetermined locations within the area, the computing device having access to one or more programs which when executed by a processor of the computing device, cause the computing device to perform the steps of: dividing the NFC tags into groups, each group including one or more NFC tags; associating a different function to each different group of NFC tags, wherein one or more NFC tags represent checkpoints in the area; receiving real-time or near-time sensing data from a NFC sensing device over a telecommunication network, the sensing data including an ID of the NFC tag being sensed and a timestamp representing a time of sensing; and performing the function associated with a given NFC tag, upon receiving sensing data including the ID of the given NFC tag.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 illustrates an example of NFC tags manufactured by 3M™;

FIG. 2 illustrates components of one embodiment of an environment in which the embodiments may be practiced;

FIG. 3 illustrates a table mapping the IDs of the tags to the function(s) associated with each tag;

FIG. 4 illustrates an example of the authentication process, in accordance with an embodiment.

FIG. 5 illustrates an example of a user interface presented to the administrator or client, in accordance with an embodiment;

FIG. 6 illustrates an example of a map provided by a third party and including and illustrating the area being monitored and the status of the checkpoints in the area;

FIG. 7 illustrates an example of a user interface illustrated on the sensing device; and

FIG. 8 is a flowchart of a method for monitoring an area using NFC tags in accordance with an embodiment.

It will be noted that throughout the appended drawings, like features are identified by like reference numerals.

### DETAILED DESCRIPTION

The embodiments now will be described more fully hereinafter with reference to the accompanying drawings, which form a part hereof, and which show, by way of illustration, specific embodiments by which the embodiments may be practiced. The embodiments are also described so that the disclosure conveys the scope of the invention to those skilled in the art. The embodiments may, however, be embodied in many different forms and should not be construed as limited to the embodiments set forth herein. Among other things, the present embodiments may be embodied as methods, portable devices, servers, computer storage media, etc. Accordingly, the embodiments may take the form of an entirely hardware embodiment, an entirely software embodiment, an embodiment combining software and hardware aspects, a user interface, etc.

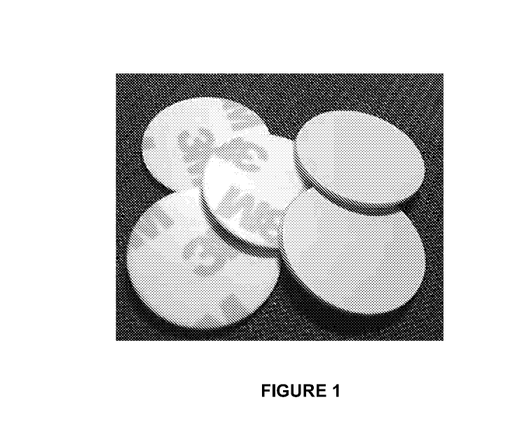

Briefly stated, the embodiments describe a system and method for monitoring an area using NFC tags. NFC (near field communication) is a wireless technology which allows for the transfer of data such as text or numbers between two NFC enabled devices or an NFC device and an NFC tag. NFC tags contain microchips with little aerials which store information for transfer to an NFC sensing device, such as a mobile phone. An example of NFC tags (hereinafter tag) manufactured by 3M™ is shown in FIG. 1.

In an embodiment, the tags are provided in specific locations within the monitored area. Each tag has an ID associated with it. A portable sensing device such as portable phone may be used to sense the tag. When the tag is sensed at least the ID of the tag is extracted/detected by the sensing device. Sensing data including (but not limited to) the ID of the tag may be sent to a remote server (or the cloud) over a wireless telecommunications network in real time or in near-time e.g. when a connection is not available. Preferably, the sending data includes also a timestamp associated with the ID of the tag. The timestamp indicating the time when the tag was sensed.

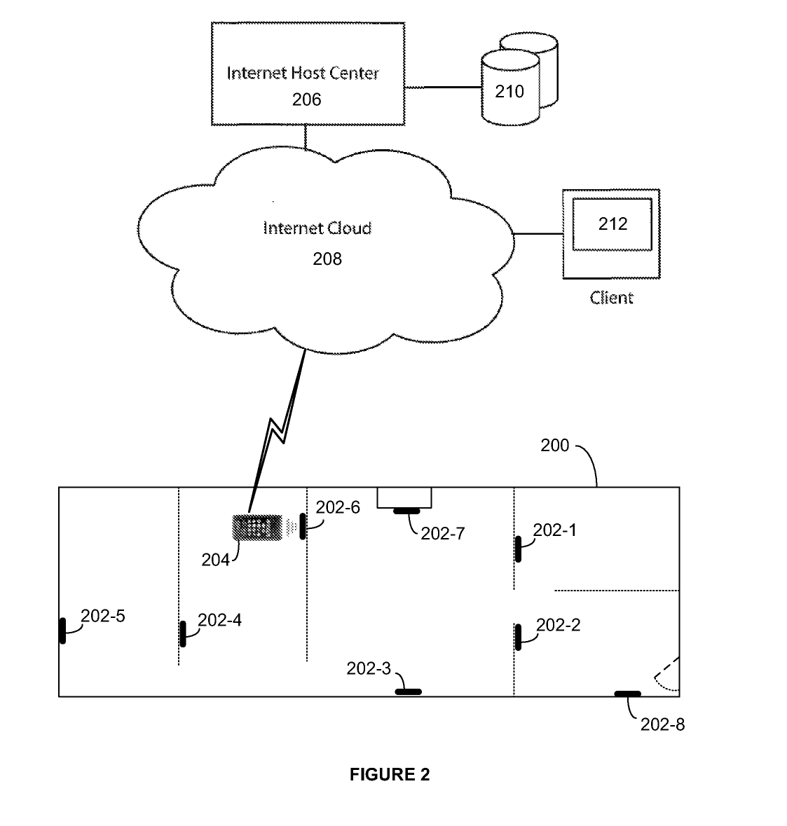

FIG. 2 illustrates components of one embodiment of an environment in which the embodiments may be practiced. Not all the components may be required to practice the embodiments, and variations in the arrangement and type of the components may be made without departing from the spirit or scope of the invention. FIG. 2 illustrates an example of an area 200 comprising a plurality of NFC tags 202 provided at predetermined locations within the area 200. The tags may be sensed using a portable sensing device 204 such as a portable phone or the like. The sensing may occur when the device 204 is brought in proximity of the tag 202 (within Approx 5 cm). In an embodiment, an application/program may be provided by the server/host 206 or from the cloud 208 for execution on the sensing device 204 to allow the sensing device 204 to perform the sensing and communicate with the host 206 etc. as discussed herein.

In an embodiment, the sensing device 204 provides sensing data including the ID of the tag being sensed, and preferably a timestamp indicating the time of sensing, to a remote host 206 or to the cloud 208 over a telecommunications link. The wireless link may include one or more of: wireless data network, wifi network, internet, LAN, WAN etc. The sensing data may be provided in real time if a continuous connection is available, or near time as soon as a connection becomes available. The sensing data may be stored in one or more databases 210 operably connected to the host 206. Accordingly, the sensing device may operate in two modes. A real time mode in the presence of a connection to the host 206 wherein the sensing data is transferred to the remote host 206 in real time as soon as the tag 202 is sensed. The other mode is the near time mode during the absence of a continuous connection. In the present case, the data is stored locally in the sensing device. As soon as a connection is detected, the sensing data may be sent to the remote host to be stored in the database or in the cloud. The user interface displaying the sending data may be refreshed/updated every time a new sensing data is received at the host 206 (aka server 206).

A client 212 may monitor the area 200 and have access to the sensing data associated with the area 200 over the internet or any similar link that allows the exchange of data between the client 212 and the host server 206.

In an embodiment, the NFC tags may be divided in groups whereby each group may include one or more tags and may have a function associated therewith, such that the sensing of any tag in a given group triggers the function associated with the group. In particular, some tags may define checkpoints in the area 200, some tags may be sensed for triggering an alarm, some tags may be sensed for authenticating the employees etc.

For example, some tags may be grouped under a first group having a Checkpoint Update function, whereby sensing of one or more of the tags in this group indicates that checking has been performed and no unusual events are happening. Other tags may be grouped in a second group having a Trigger Alarm function, whereby sensing of one or more tags in the second group may cause the triggering of an alarm. Several kinds of alarms may exist including one or more of: triggering an audio alarm, calling an emergency number e.g. 911, calling an intervention team, activating video/audio recorders in the sensing device, activating video/audio recorders in the area 200. It is also possible to have a different group for each type of alarms. Any one of the alarms discussed herein may be referred to as the first alarm, the second alarm, the third alarm, the fourth alarm etc.

In an embodiment, sensing of some tags may cause an email (or sms or voicemail, or any similar messaging means) to be generated and sent to the client indicating that the checkpoint has been visited/ckecked. The email may also include the time at which the sensing occurred and/or the name of the personnel who performed the sensing.

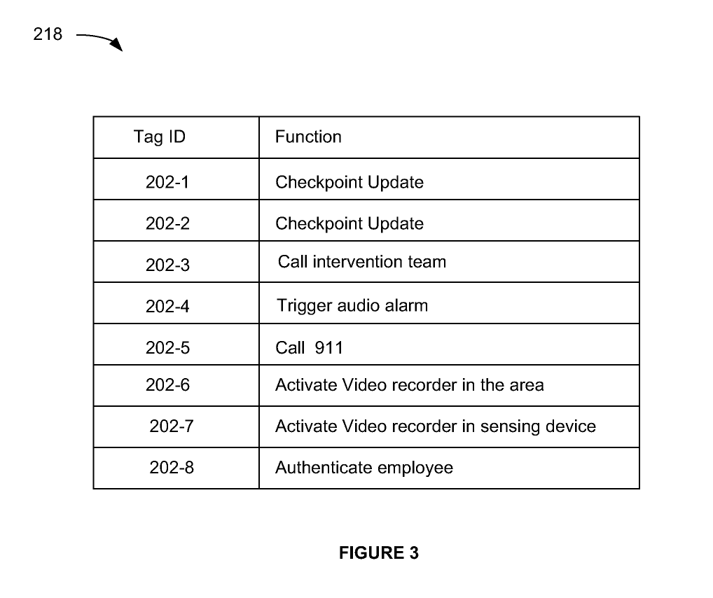

In an embodiment, a table may be provided including the IDs of the tags, and the function associated with each tag. It is possible that one or more of the tags is classified in more than one group whereby more than one function may be performed following the sensing of a single tag. An example of a table 218 is illustrated in FIG. 3. In an embodiment, the table 218 may be provided in the database 210. Upon receipt of sensing data including the ID of a given tag, the host 206 may access the table 218 to determine the function associated with the sensed tags. The host 206 may then perform the function associated with the tag 202 or send instructions to the sensing device 204 or another party to perform the function.

In another embodiment, a portion or the entire table 218 may be stored on the sensing device 204 so that the function may be performed immediately by the sensing device 204 without an authorization/instruction from the host 206. This scenario is particularly important in emergency situations in which the connection to the host is not available. In these situations, the sensing device can take actions in the absence of instructions from the host 206. For example, assuming that the function associated with the sensed tag is to call 911 and/or contact the intervention team, if the connection to the host is not available, the sensing device 204 may proceed to perform the function on its own. A report may be sent later to the host when the connection is established to report the sensing data in a batch, and to report the activities/functions performed by the sensing device 204 when the connection was not available. In an embodiment, the host 206 and sensing device 204 may be connected in a master slave configuration whereby in the presence of a connection between the two, the sending device 204 executes the instructions sent by the host 206. By contrast, the sensing device 204 may also perform some of the functions independently when the connection is not available.

In an embodiment, the sensing device 204 may include a positioning system such as a GPS or the like which allows for determining the location of the sensing device 204 at a given time. In the present embodiment, the sensing device 204 may be configured to include into the sensing data the coordinates of the sensing device 204 at the time of sensing a specific tag. In this case, the sensing data sent to the host 206 may include at least the ID of the tag 202, the time of sensing, and the location coordinates of the sensing device 204 at the time of sensing. When the sensing data is received at the host 206, the host 206 may compare the predetermined location of the tag 202 with the coordinates of the sensing device 204 at the time of sensing. If a mismatch occurs, an alarm may be triggered to investigate the reason for the mismatch, and to determine if the system was hacked.

In another embodiment, the sensing device may be configured to report its position (coordinates) to the host continuously (or periodically or upon request from the host) so that the host 206 may trigger an alarm when the sensing device 204 remains in the same location for a given period, and/or when the sensing device 204 leaves the monitored area 200 an/or enters into a sub-area where the employees are not allowed to enter.

In an embodiment, each employee has to provide authentication information before having access to the sensing device 204 and/or running the program which allows for performing the sensing. In an embodiment, the authentication may include one or more of: providing username and password, sensing an authentication tag, biometric verification, etc. Examples of biometric verification may include one or more of: fingerprint, voice recognition, retina scan, face recognition etc. These may be performed on the sensing device 204 or on a separate device which may then allows for activation of the sensing program on the sensing device 204.

In an embodiment, it is possible to randomly change the authentication information needed to provide access to the system. For example, in one instance the system may require the employee to enter the username and password, in another instance the system may ask the employee to speak in front of the microphone or stand in front of a camera or swipe a finger on fingerprint reading pad or any combination of the above. This way, it would be very difficult for an intruder to expect the type of authentication information needed to hack the system.

Using the authentication information, it is possible to identify the employee performing the sensing. In an embodiment, the employee identification information may be included in the sensing data sent by the sensing device 204. In an embodiment, if the authenticating information does not match the pre-stored authentication information an alarm may be generated indicating the presence of an intruder.

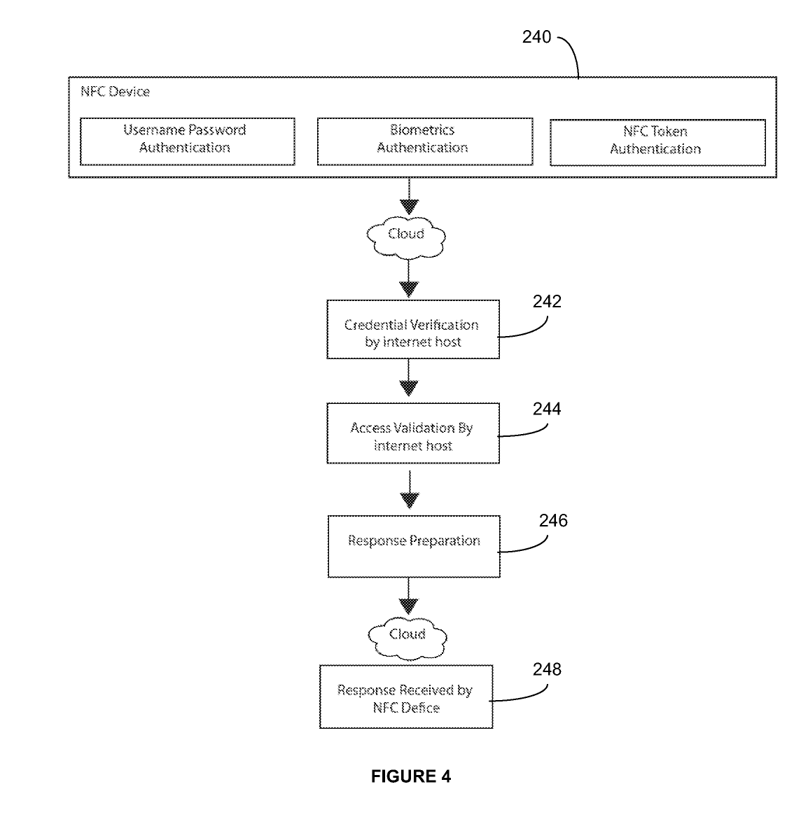

FIG. 4 illustrates an example of the authentication process, in accordance with an embodiment. As shown in FIG. 4, the authentication process may begin at step 240 by providing identification information including one or more of: a combination of username and password, biometric data/information, and an NFC authentication token. The info is then sent to the cloud to be verified by the internet host at steps 242, at step 244 the host validates the access and prepares and send a response at step 246. At step 248 the response is received by the sensing device. The response could be an access denied, or access permitted depending on the authentication information sent at step 240.

In an embodiment, a set of rules is associated with each checkpoint (or tags). The set of rules includes at least a time rule indicating the sensing times (schedule) of the checkpoint. In an embodiment, the sensing device may generate an alarm when a scanning time of a checkpoint is past due or near due to alert the employee performing the sensing. The alarm may be generated by the sensing device itself or may be performed using instructions received from the host. In an embodiment, the host 206 may provide the sensing schedule to the sensing device upon authentication whereby the employee may review the schedule and begin the sensing using the predetermined schedule. It is also possible to change the schedule of one or more checkpoints in the area 200 from the host 206 depending on the needs/situations and also to assess the employee's ability to follow the instructions.

As discussed above, the tags may have different functions associated therewith. In one embodiment, one or more tags 202 may have a panic-alarm function associated therewith whereby sensing of one or more of these tags 202 may cause activation of the audio/video recorder associated with the sensing device 204 and/or audio and video recorders installed within the area 200. As discussed above, the decision to activate the video and/or audio recorders may be taken by the sensing device 204 automatically upon sensing a certain tag, or upon receiving instructions from the host 206 after sending sensing data including the ID of the given tags. The video/audio file may then be sent to the remote host 206 over the communications network for viewing and/or recording purposes.

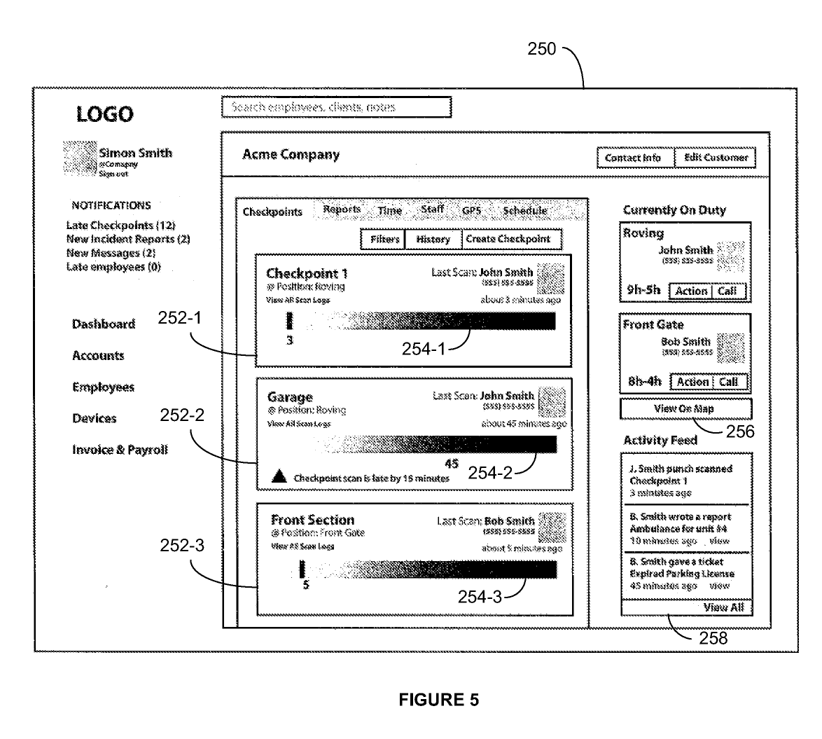

In an embodiment, a user interface may be provided including a visual illustration of the sensing data and the rules associated with the tags provided in the area 200. FIG. 5 illustrates an example of a user interface 250 presented to the administrator or client 212 in accordance with an embodiment. As shown in FIG. 5, the interface 250 includes one or more regions 252, each region 252 representing a checkpoint. The region 252 indicates the status of the checkpoint including the time of the last scan (sensing event). In an embodiment, the regions 252 may include a region 254 which represents the status of the checkpoint using colors. The region 254 may be color coded to illustrate different colors in accordance with the status of the checkpoint. For example, if the checkpoint is scanned/checked on time the color may be green. If the checkpoint is past due but within a predefined limit, the color may be yellow, and if the checkpoint is past due and past the predefined limit, the color may be red. Needless to say, the embodiments are not limited to this choice of colors as other colors may also be used.

The interface may also indicate the names of the employee that are on duty, as well as the option to view the location of each employee on the map as indicated at 256. In an embodiment, the interface 250 may also show the recent activities of the employees as indicated at 258.

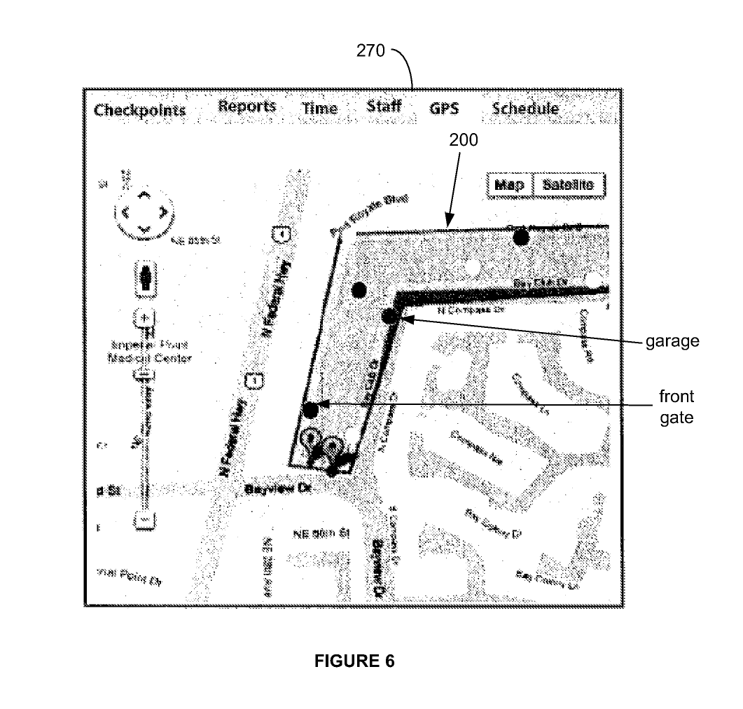

In an embodiment, the interface may illustrate the area 200 on a map 270 provided by a third party such as for example, Google Maps™, whereby the user/client/administrator may view the area 200 on the map along with the statuses of the checkpoints. FIG. 6 illustrates an example of a map provided by a third party and illustrating the area being monitored and the status of the checkpoints in the area. In a non-limiting example of implementation, the interface may receive the necessary code for illustrating the map from the server providing the map e.g. Google Map™ server, and modify the code to add the coordinates/dimensions of the area 200 and mark the checkpoints in the area; e.g., using a visual marker such as a circle, rectangle or the like. In an embodiment, the checkpoints may be provided in colors that represent the status of each checkpoint.

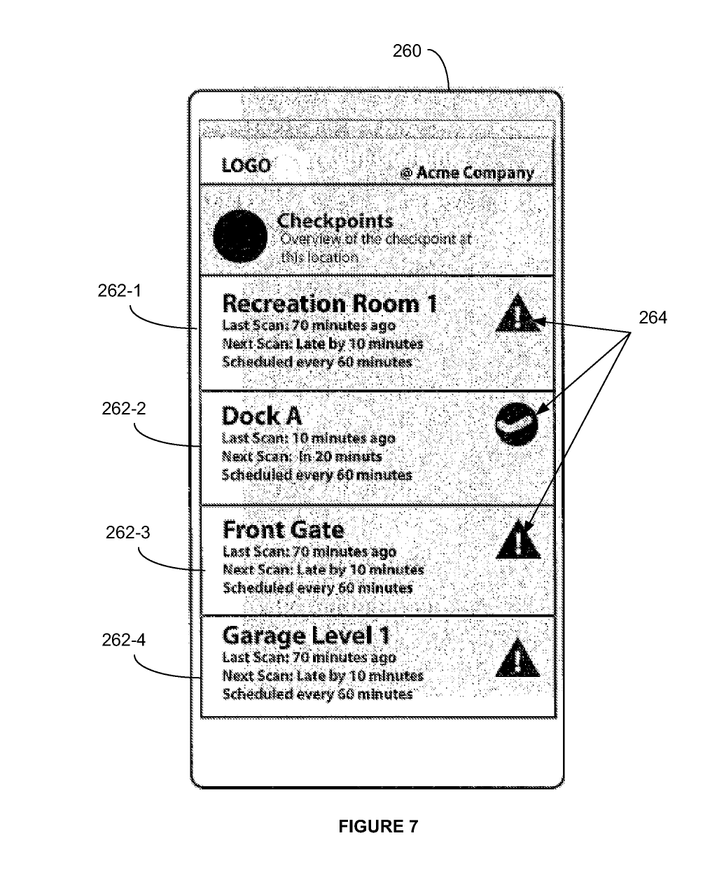

FIG. 7 illustrates an example of a user interface 260 illustrated on the sensing device 204 for the personnel performing the sensing. As shown in FIG. 6, the interface 260 indicates the status of one or more checkpoints and provides a region 262 for each checkpoint. The region 262 includes information about the checkpoint including but not limited to an identification of the checkpoint e.g. garage, front gate etc., a symbol 264 indicating the status of the checkpoint, the time rule associated with the checkpoint, time of the last scan, time of the next scan, time between scans etc.

In an embodiment, the sensing data may be stored in the database 210 or in the cloud. The sensing data may be stored in one or more predefined formats which allow for generating reports, invoices, employee evaluation punch time clock (punch in, punch out) etc.

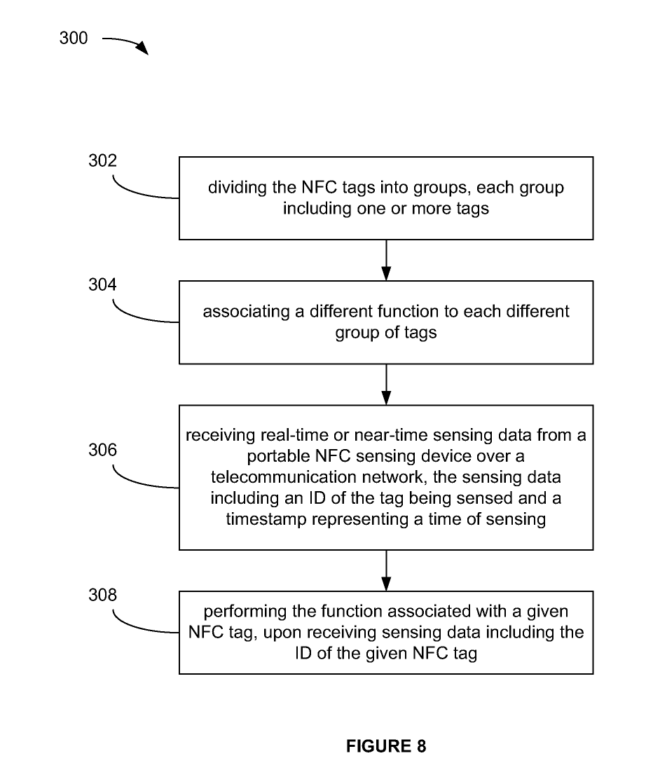

FIG. 8 is a flowchart of a method for monitoring an area using NFC tags. The method begins by dividing the NFC tags into groups, each group including one or more tags at step 302. Step 304 comprises associating a different function to each different group of tags. Step 306 comprises receiving real-time or near-time sensing data from a portable NFC sensing device over a telecommunication network, the sensing data including an ID of the tag being sensed and a timestamp representing a time of sensing. Step 308 comprises performing the function associated with a given NFC tag upon receiving sensing data including the ID of the given NFC tag.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for monitoring an area including a plurality of NFC tags provided in predetermined locations within the area, the method comprising:
dividing the NFC tags into groups, each group including one or more NFC tags;
associating a different function to each different group of NFC tags, wherein one or more NFC tags represent checkpoints in the area;
receiving real-time or near-time sensing data from a sensing device adapted to sense NFC tags over a telecommunication network, the sensing data including an ID of the NFC tag being sensed and a timestamp representing a time of sensing;
performing the function associated with a given NFC tag, upon receiving sensing data including the ID of the given NFC tag.

2. The method of claim 1, wherein the sensing device includes a positioning system, the method further comprising:
receiving a position of the sensing device at the time of sensing;
comparing the position of the sensing device with a predetermined location of the NFC tag;
triggering a first alarm when a mismatch is identified.

3. The method of claim 1, wherein the sensing device includes a positioning system, the method further comprising:
receiving a position of the sensing device;
triggering a second alarm when the sensing device remains in a certain location for a given period.

4. The method of claim 1, wherein the sensing device includes a positioning system, the method further comprising:
receiving a position of the sensing device;
triggering a third alarm when the sensing device leaves the area.

5. The method of claim 1, further comprising providing the sensing device with computer readable instructions which when executed cause the sensing device to sense the NFC tags when brought in proximity of the NFC tags, and send the sensing data to a remote host over the telecommunication network in real time or as soon as a connection is available.

6. The method of claim 5, wherein a panic-alarm function is associated with a first group of NFC tags, the computer readable instructions causing the sensing device to:
activate an audio/video recorder associated with the sensing device, when sensing one or more NFC tags from the first group of NFC tags; and
send a recorded audio/video file to the remote host.

7. The method of claim 5, wherein a panic-alarm function is associated with a second group of NFC tags, the method further comprising:
upon receiving sensing data including the ID of one or more NFC tags from the second group, sending instructions to the sensing device to activate an audio/video recorder associated with the sensing device; and
receiving an audio/video file from the sensing device.

8. The method of claim 5, wherein the sensing device is configured to perform an employee authentication before sensing NFC tags, the computer readable instructions causing the sensing device to include an employee authentication information with the sensing data.

9. The method of claim 8, wherein the sensing device authenticates employees using biometric verification, the method further comprising triggering a fourth alarm when a biometric data received/detected at the sensing device does not match any employee.

10. The method of claim 5, wherein the computer readable instructions cause the sensing device to generate an alarm when a scanning time for a certain checkpoint is past due.

11. The method of claim 1 further comprising illustrating a status of one or more checkpoints in a user interface.

12. The method of claim 11, further comprising color coding illustrated checkpoints using the sensing data and a set of rules specific to each checkpoint.

13. The method of claim 12, further comprising illustrating the area, the checkpoints, and the color associated with each checkpoint on a map provided by a third party.

14. The method of claim 12, wherein the set of rules comprises a time rule that defines scanning times for each checkpoint.

15. The method of claim 12, further comprising refreshing the user interface every time a new sensing data is received for one of the checkpoints.

16. The method of claim 15, further comprising generating a late log for a given checkpoint when a time rule is broken.

17. The method of claim 16, further comprising changing the color of the given checkpoint in accordance with the late log.

18. The method of claim 1, further comprising:
storing the sensing data in a predefined format in a database;
generating one or more reports based on the sensing data stored in the database.

19. A method for monitoring an area including a plurality of NFC tags provided in predetermined locations within the area, a portion of the NFC tag representing checkpoints in the area, the method comprising:
associating a function to each tag;
receiving real-time or near-time sensing data from a NFC sensing device over a telecommunication network, the sensing data including an ID of the tag being sensed and a timestamp representing a time of sensing;
performing the function associated with a given NFC tag, upon receiving sensing data including the ID of the given NFC tag.

20. A computing device for monitoring an area including a plurality of NFC tags provided in predetermined locations within the area, the computing device having access to one or more programs which when executed by a processor of the computing device, cause the computing device to perform the steps of:
dividing the NFC tags into groups, each group including one or more NFC tags;
associating a different function to each different group of NFC tags, wherein one or more NFC tags represent checkpoints in the area;
receiving real-time or near-time sensing data from a NFC sensing device over a telecommunication network, the sensing data including an ID of the NFC tag being sensed and a timestamp representing a time of sensing;
performing the function associated with a given NFC tag, upon receiving sensing data including the ID of the given NFC tag.
